(19) United States
(12) Patent Application Publication
(10) Pub. No.: US 2018/0318958 A1
(43) Pub. Date: Nov. 8, 2018

(54) LASER INDUCED STRUCTURAL MODIFICATION OF PAPERBOARDS

(71) Applicant: BOBST MEX SA, Mex (CH)

(72) Inventors: Sébastien EQUIS, Penthalaz (CH); Patrik HOFFMANN, Schüpfen (CH); Gilles PILLONEL, Font (CH); Sébastien VAUCHER, Thun (CH); Kilian WASMER, Choëx (CH)

(21) Appl. No.: 15/773,361

(22) PCT Filed: Nov. 10, 2016
(86) PCT No.: PCT/EP2016/025141

§ 371 Date: May 3, 2018

(30) Foreign Application Priority Data
Nov. 11, 2015 (EP) 15020225.7

(51) Int. Cl. B23K 26/00; B31B 50/25; B31B 50/74; B31F 1/08

(52) U.S. Cl. CPC B23K 26/0006; B31B 50/25; B23K 2103/40; B31F 1/08; B31B 50/741

(57) ABSTRACT

A method for locally modifying a structure of a paperboard. A penetrating region (114) of the paperboard (110) is penetrated by laser radiation (102) such that moisture in the penetrating region (114) evaporates for locally modifying the structure of the penetrating region (114) e.g. by weakening the paperboard at the region and for deforming it there.

### CROSS-REFERENCE TO RELATED APPLICATIONS

The present application is a 35 U.S.C. §§ 371 national phase conversion of PCT/EP2016/025141, filed Nov. 10, 2016, which claims priority of European Patent Application No. 15020225.7, filed Nov. 11, 2015, the contents of which are incorporated by reference herein. The PCT International Application was published in the English language.

### ART BACKGROUND

Nowadays paperboards are a favorite material in the packaging industry. Common paperboards form a robust but also formable packaging.

Furthermore, the paperboards are suitable for imprinting product description and promotion symbols.

In order to form a packaging out of paperboards, creasing methods are applied. Creasing is a local weakening of paperboard that allows bending along a specific line. It is widely used in the packaging industry for the production of paperboard boxes, for example.

Nowadays, the creasing process is done by mechanical interaction using a creasing rule 803 and a cavity 805 of a conventional support table 804 onto which the paperboard 800 is located as shown in FIG. 8. During the creasing process the mechanical creasing rule 803 usually presses the paperboard 800 on the printed outer liner 802 and a creasing line (rib) is formed along the inner liner 801 of the paperboard 800. Once creased, the paperboard 800 can be easily bent in the direction of a creasing line. The inner liner 801 and outer liner 802 are the first layers of cellulose on each side of the paperboard 800. A coating is usually covering the liners 801, 802 for enhancing the smoothness and printability. This creasing method allows optically proper creasing lines with no cracking of the inner and outer liners 801, 802 after bending. However, core layers usually separate from one another during the creasing so that the structure becomes more flexible without elongation weakening.

However, each paperboard product needs its respective creasing rule 803 and matrix. This may cause storage problem, costs and a limited flexibility. The installation of the creasing rule 803 is also time consuming, which is a limiting factor for the production of small series.

### SUMMARY OF THE INVENTION

It is an object of the present invention to provide an efficient and smooth locally modifying the structure and machining of a paperboard.

This object is solved by a method for locally modifying the structure of a paperboard and a device for locally modifying the structure of a paperboard disclosed herein.

According to a first aspect of the present invention, a method for mild locally modifying a structure of a paperboard is presented. According to the method, the paperboard to be penetrated is provided. A penetrating region of the paperboard is penetrated by a laser radiation such that moisture in the penetrating region (for example specifically in a core section of the paperboard) evaporates for modifying the structure of the penetrating region.

According to a further aspect of the present invention, a device for modifying a structure of a paperboard by the above described method. The device comprises a holding device for holding the paperboard. Furthermore, the device comprises the laser device for penetrating the penetrating region of the paperboard by the laser radiation such that the moisture in the penetrating region (for example specifically in a core section of the paperboard) evaporates for modifying the structure of the penetrating region.

A paperboard describes generally a heavy-duty paper of various strengths, ranging from a simple arrangement of a single thick sheet of paper to complex configurations featuring multiple corrugated and flat layers. The paperboard may be made of a first cover layer and a second cover layer between which a core section of the paperboard is arranged. The cover layers may define layers which enclose the core section. The first cover layer may be a top layer and the second cover layer may be a bottom layer, or vice versa. The first and/or second cover layer may be a coated cover layers or untreated paper layers, for example.

Specifically, a duplex paperboard is available which is made of e.g. recycled fibers. It may have in the front side (e.g. the first cover layer) a triple pigment coating suitable for printing. The backside (e.g. the second cover layer) may have a thin coating that enhances the smoothness of the paperboard. The core may be made of approx. 60% Post Consumer Waste (PCW), approx. 20% Post Industrial Waste (PIW) and approx. 10% fresh mechanical pulp. Except for the layer of unprinted PIW that is white, all the rest is grey. This type of paperboard is cheap and has many packaging applications.

A high quality fully coated white (bleached) paperboard may have both cover layers with a white pigment coating enhancing printability. The core section comprises layers made of bleached chemical pulp. Besides the advantage of a white color, white paperboard made out of bleached chemical pulp has the advantage of being stiffer.

In the paperboard industry, it is an aim to print the cover layers of the paperboards and to crease and bend the paperboards very mild and smooth without damaging the structure of the paperboards. According to the approach of the present invention, the laser radiation is adjusted to evaporate moisture within the paperboard without burning, ablating or cutting the layers. The moisture may originate from the air within the core section and/or from the paperboard material within the core section itself. The evaporated moisture causes a volume increase of the water vapor, when it is heated by the irradiation. This causes a delamination of the layers, i.e. of the cellulose fiber layers, in the core section of the paperboard. In other words, the evaporated moisture causes a weakening because the bond between the layers is weakened and/or is cancelled i.e. due to a mechanical stress (i.e. by the caused vapor pressure). Hence, the penetration region has less bending resistance and the risk of cracking the fibers during the machining, e.g. during bending, is reduced.

Summarizing, by penetrating the penetration region by the laser radiation, a locally modification of the structure of the paperboard is achieved. For example, a weaker and hence very flexible region may be formed so that bending lines may be generated. The swelling effect can also be used for creating complex and harder embossing structures in the cover layers (such as graphic structures, Braille).

After the machining, i.e. the creasing or the swelling of the layers as described above, the paperboard may have a permanent weakness due to the delaminating of the layers so that the cardboard can be folded many days (or months) later. The role of the water is to evaporate and perform the mechanical work for the delamination (i.e. breaking the bonds between the e.g. inner layers).

According to a further exemplary embodiment, the method further comprises the step of creasing the paperboard along the penetrating region, wherein the penetrating region describes a creasing line along which the paperboard is intended to be bent. As described above, a smooth and non-destroying creasing of the paperboard along the creasing line may be accomplished.

According to a further exemplary embodiment, the device further comprises a bending device for bending the paperboard along the penetrating region, i.e. the creasing line. The bending device may comprise for example two clamping sections which clamp respective clamping parts of the paperboard. The bending device may further move the respective clamping sections with respect to each other, such that a creasing and bending of the paperboard clamping parts along the creasing line may be accomplished automatically.

According to a further exemplary embodiment, in the step of penetrating the penetrating region, the paperboard and, in particular, the core section is penetrated in such a way that the evaporated moisture deforms and hence modifies the structure of the paperboard and, in particular, at least the first cover layer, wherein the penetrating region describes an embossing structure, in particular a Braille letter, a number or a symbol. By adding for example additives as described more in detail below, the modified structure may form a hard and undeformable embossing structure.

Hence, by adjusting the laser radiation in such a way that more moisture in the core section evaporates, the core section and additionally at least the first cover layer swells due to the evaporating moisture. The swelled section of the first cover layer has protrusions and sinks which are visible and haptic sensible. Hence, by the deformation of the at least first cover layer due to the evaporation of moisture, desired graphic symbols can be printed onto the first layer. The graphic symbols may be for example pictures or letters. Specifically, Braille letters, numbers or any other symbol may be formed onto the first layer.

According to a further exemplary embodiment, a swelling level within the core section at the penetrating region before the step of penetrating the penetrating region is adjusted. In the step of adjusting the swelling level there is introduced at least one swelling additive adapted for swelling under influence of the laser radiation such that the harder embossing structure of the first layer is generated.

The swelling additive is adapted to form a hardened structure within the core section and/or the first cover layer in reaction with the laser radiation. Hence, a robust and withstanding embossing graphic structure may be formed.

According to a further exemplary embodiment, a moisture level within the penetrating section and in particular the core section at the penetrating region before the step of penetrating the penetrating region is adjusted. In the step of adjusting the moisture level, at least one moisture levelling additive is introduced for gas generation by the laser radiation within e.g. the core section at the penetrating region such that the penetrating section is weakened.

Accordingly, the evaporated moisture may be adjusted and hence provide a volume increase of the vapor, heated by the irradiation. This causes a controlled above described delamination of the layers in the core section of the paperboard. The controlled evaporated moisture causes a weakening because the bond between the layers is weakened and/or is cancelled i.e. due to a mechanical stress (i.e. by the caused pressure of the vapour). Hence, the penetration region has less bending resistance and the risk of cracking the fibers during the machining, e.g. during bending, is reduced.

Summarizing, in order to achieve sufficient evaporation of moisture in order to have a desired swelling of the penetrating region, the moisture, i.e. the amount of water or other suitable liquid to be evaporated within the core section, may be adjusted. The moisture may be adjusted, for example, by applying wet tissue along the penetrating region, or by locally spraying, ink jetting, or printing water or another suitable liquid such as alcohols, polyalcohols, organic ethers, organic or inorganic esters, hydrocarbons, or silicone oils, or mixtures of two or more of these substances. Furthermore, the paperboard may be located in a climate chamber (e.g. a desiccator or humidity controlled container) where a desired humidity (and moisture, respectively) is adjustable for increasing the moisture of the paperboard. It is also possible to inject a liquid, such as water, saturated salt solutions and/or aluminum hydroxide directly into the core section before penetrating the penetrating region with the laser radiation.

In particular, specific additives for gas production may be added in inner layers of the multi-layered paperboard. The specific gas producing additives may be already present in paperboard and they could be intentionally added for better laser creasing ability by evaporating parts of or entirely the specific gas producing additives.

The liquid may serve as a vapor source and/or to adjust a scattering of the laser radiation inside cardboard or paperboard material.

According to a further exemplary embodiment, the laser radiation comprises a power density of approximately 10⁴ W/cm² to approximately 10⁶ W/cm², preferably 10⁵ W/cm².

According to a further exemplary embodiment, the laser radiation comprises deposited power, in particular within the core section of the paperboard of approximately 10 W/cm² to approximately 10³ W/cm², preferably 10² W/cm².

According to a further exemplary embodiment, the laser radiation has a wavelength of approximately 1000 nm to approximately 11000 nm, in particular approximately 4000 nm to approximately 8000 nm.

Hence, by the above described values for the power density, the deposited power and the wavelength, a proper evaporation of moisture without destroying the structure of the paperboard material may be achieved. Other types of paperboards might work best with either higher or smaller power densities and also other wavelength optima might be desirable for other paperboards.

According to a further exemplary embodiment, the laser radiation is a pulsed laser radiation generated by a pulsed laser device. The laser device may be selected from the group consisting of ultra-short pulsed lasers and short pulsed lasers.

According to a further exemplary embodiment, the laser radiation is a continuous laser radiation generated by a continuous laser device.

According to a further exemplary embodiment, the laser radiation is generated by a diode laser.

According to a further exemplary embodiment, the laser radiation is generated by a Near Infrared Laser (NIR) Nd:YAG 1064 nm laser, other rare earth doped crystals such as Ytterbium or rare earth element doped fibre lasers with wavelength in the near infrared, e.g. 1074 nm. Holmium: Yttrium-Iron-Garnet YIG, Holmium: Yttrium-Aluminium-Garnet YAG, or Holmium: Yttrium-Lithium-Fluoride YLF at a wavelength of 2100 nm; or mid Infrared lasers (MIR) Fe²⁺:ZnSe lasers can emit at 3.7-5.1 μm; CO-Laser 5200 nm-6300 nm.

According to a further exemplary embodiment, the laser radiation is generated by a carbon dioxide laser (e.g. 9100 nm-11000 nm).

According to further exemplary embodiment, the penetrating region may be penetrated by the laser radiation such that penetration spots at which the moisture evaporates are generated. Additionally or alternatively, the penetrating region may be penetrated by the laser radiation such that a constant line (straight and/or curved) along which the moisture evaporates is generated.

Two adjacent penetration spots are spaced apart from each other at a distance. Alternatively, two adjacent penetration spots may overlap such that a continuous penetration region is formed, wherein the plurality of penetration spots partially overlap with neighboring penetration spots.

It has to be noted that embodiments of the invention have been described with reference to different subject matters. In particular, some embodiments have been described with reference to apparatus, whereas other embodiments have been described with reference to methods. However, a person skilled in the art will gather from the above and the following description that, unless other notified, in addition to any combination of features belonging to one type of subject matter also any combination between features relating to different subject matters, in particular between features of the apparatus and features of the methods as disclosed with this application.

### BRIEF DESCRIPTION OF THE DRAWINGS

The aspects defined above and further aspects of the present invention are apparent from the examples of embodiments to be described hereinafter and are explained with reference to the examples of embodiments. The invention will be described in more detail hereinafter with reference to examples of embodiments but to which the invention is not limited.

FIG. 1 shows a schematic view of a device for modifying the structure a paperboard according to an exemplary embodiment of the present invention.

FIG. 2 shows a schematic view of a continuous penetration line along a paperboard according to an exemplary embodiment of the present invention.

FIG. 3 shows a schematic view of a penetration spots along a paperboard according to an exemplary embodiment of the present invention.

FIG. 4 shows a schematic view of a flow chart of the method for modifying the structure a paperboard according to an exemplary embodiment of the present invention.

FIG. 5 shows a schematic view of a paperboard onto which first cover layer a letter is formed according to an exemplary embodiment of the present invention.

FIG. 6 shows a sectional view of a paperboard according to an exemplary embodiment of the present invention.

FIG. 7 shows a schematic view of a paperboard comprising a plurality of creasing lines according to an exemplary embodiment of the present invention.

FIG. 8 shows a schematic view of a conventional creasing device.

### DETAILED DESCRIPTION OF EXEMPLARY EMBODIMENTS

The illustrations in the drawings are schematic. It is noted that in different figures similar or identical elements are provided with the same reference signs.

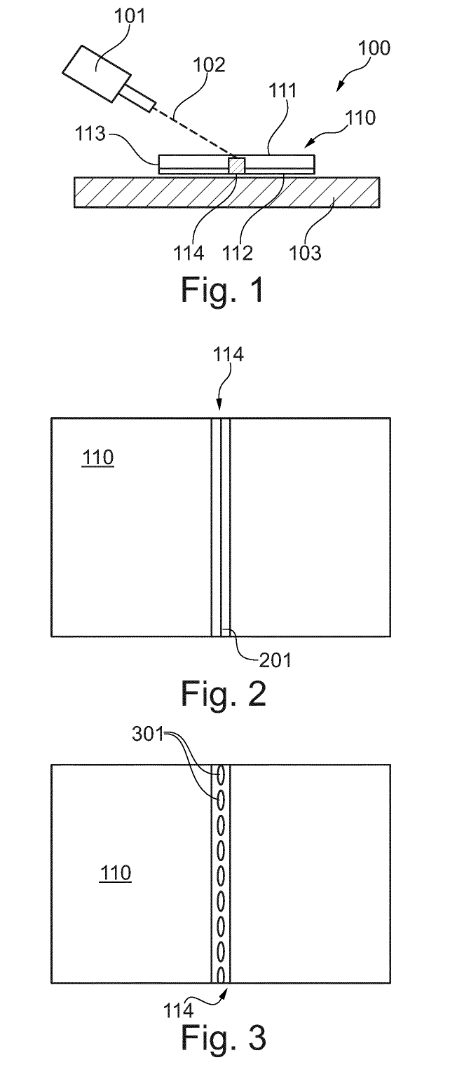

FIG. 1 shows a device 100 for locally modifying a structure of a paperboard 110. The paperboard 110 is supported on a holding device 103, e.g. a workbench. A laser device 101 is arranged relative to the paperboard 110 for penetrating a penetrating region 114 of the paperboard 110 by laser radiation 102 such that moisture in the core section 113 evaporates for modifying the structure (e.g. weakening or embossing) of a penetrating region 114. The paperboard 110 illustrated is comprised of a first cover layer 111 and a second cover layer 112 between which a core section 113 of the paperboard 110 is arranged. A penetrating region 114 of the paperboard 110 is penetrated by laser radiation 102 such that moisture in the core section 113 is evaporated for modifying the structure of the penetrating region 114.

The laser radiation 102 is adjusted to evaporate moisture within the selected paperboard 110. The moisture may originate from the air within the core section 113 and/or from the paperboard material within the core section 113 itself. The evaporated moisture causes delamination of the layers in the core section of the paperboard. Furthermore, by penetrating the penetrating region 114 by the laser radiation, a very flexible penetrating region 114 may be formed, particularly in contrast to other regions, so that complex graphic structures or creasing lines may be generated.

The penetrating region 114 weakened due to evaporation of moisture may be used for bending the paperboard 110 along the penetrating region 114, wherein the penetrating region describes a creasing line along which the paperboard 110 is intended to be bent. As described above, a smooth and non-destroying bending of the paperboard 110 along a creasing line 201 (see FIG. 2) may be accomplished.

FIG. 2 shows a schematic view of a continuous penetration line, such as a creasing line 201, along a paperboard 110 according to an exemplary embodiment of the present invention. The laser radiation 102 that produced the line 201 may be, for example, a continuous laser radiation generated by a continuous laser device such that a constant line (straight and/or curved) along which the moisture evaporates is generated.

FIG. 3 shows a schematic view of a plurality of penetration spots 301 along a paperboard 110 according to an exemplary embodiment of the present invention. In this embodiment, the laser radiation 102 is a e.g. pulsed laser radiation generated by a pulsed laser device. The laser device 101 may be selected from the group consisting of ultra-short pulsed lasers and short pulsed lasers.

The penetrating region 114 is penetrated by the laser radiation such that penetration spots 301 at which the moisture evaporates are generated. Two adjacent penetration spots 301 are shown spaced apart from each other at a distance. Alternatively, two adjacent penetration spots 301 may overlap such that a continuous penetration region 114 is formed, wherein the plurality of penetration spots 114 partially overlap with neighboring penetration spots 114.

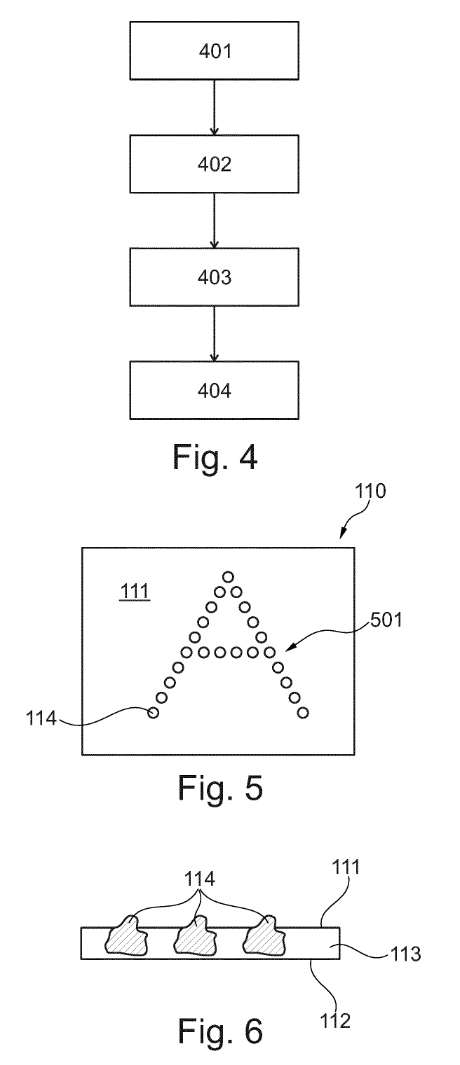

FIG. 4 shows a schematic view of a flow chart of the method for modifying the structure of a paperboard 110 according to an exemplary embodiment of the present invention. According to the method, the paperboard 110 to be creased is provided (step 401), wherein the paperboard 110 is made of a first cover layer 111 and a second cover layer 112 between which a core section 113 of the paperboard 110 is arranged. A penetrating region 114 of the paperboard 110 is penetrated by a laser radiation 102 (step 403) such that a moisture in the core section 113 evaporates for modifying the structure of the penetrating region 114.

The method further comprises adjusting the moisture within the core section at the penetrating region before the step of penetrating the penetrating region (step 402). In order to achieve a sufficient evaporation of moisture in order to have a desired swelling of the penetrating region 114, the moisture within the core section 113 may be adjusted.

Finally, the paperboard 110 is creased 404 along the penetrating region 114, wherein the penetrating region 114 describes a creasing line 201 along which the paperboard 110 is intended to be bent.

FIG. 5 shows a schematic view of a paperboard 110 onto which the first cover layer 111 an embossing graphic structure (graphic symbol 501), such as a letter, is formed. In the step of penetrating the penetrating region 114 the core section 113 is penetrated in such a way that the evaporated moisture deforms at least the first cover layer 111, wherein the penetrating region describes the graphic structure 501, in particular a Braille letter, number, or any symbol.

Hence, by adjusting the laser radiation 102 in such a way that a greater amount of moisture in the core section 113 evaporates, the core section 113 and additionally at least the first cover layer 111 swells due to the high evaporating moisture. The swollen/swelled section of the first cover layer 111 has protrusions and sinks which are visible and haptic sensible. Hence, by the deformation of the at least first cover layer 111 due to the evaporation of moisture, desired graphic symbols 501 can be printed onto the first layer. The graphic symbols 501 may be pictures and letters for example. Specifically, Braille letters, numbers or any symbol may be formed onto the first layer.

In particular, a swelling additive may be injected into the core section 113, which is adapted to form a hardened structure within the core section 113 and/or the first cover layer 111 in reaction with the laser radiation 102. Hence, a robust and withstanding embossing graphic structure 501 is formed.

FIG. 6 shows a sectional view of a paperboard 110 according to an exemplary embodiment of the present invention. Specifically, the sectional view in FIG. 6 shows the paperboard 110 as shown in FIG. 5. In order to form an embossing graphic structure, i.e. a graphic symbol, 501 in the first layer 111, the laser radiation 102 evaporates the moisture in the core section 113 within the penetration region 114 such that also the first layer 111 swells. Hence, protrusions which are visible and haptic sensible are formed. After swelling the paperboard 110, the protrusions remain visible and haptic sensible.

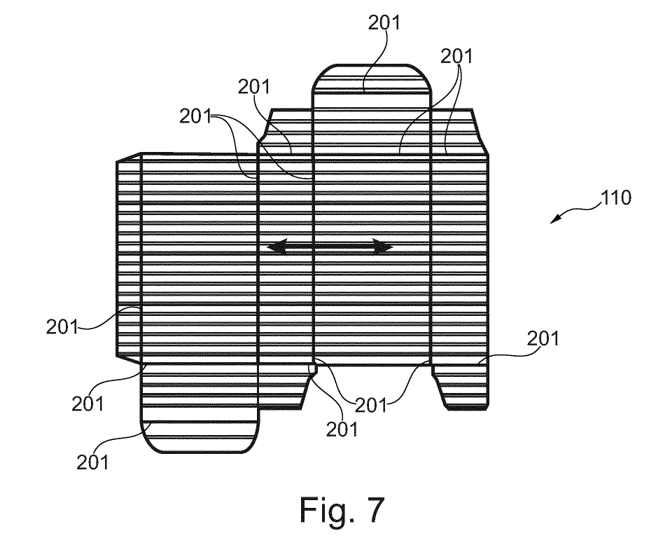

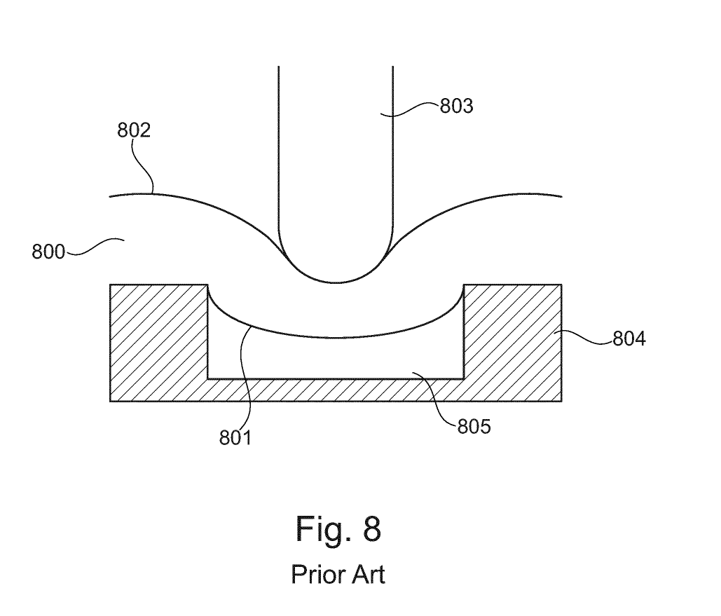

FIG. 7 shows a schematic view of a paperboard 110 comprising a plurality of creasing lines 201 according to an exemplary embodiment of the present invention. The pattern of the creasing lines 201 is formed by the laser radiation 102. The creasing lines 201 form delaminated sections of the paperboard 110. In a next step, the paperboard 110 may be bent along the creasing lines 201, so that e.g. a box may be formed.

It should be noted that the term “comprising” does not exclude other elements or steps and “a” or “an” does not exclude a plurality. Also elements described in association with different embodiments may be combined.

### LIST OF REFERENCE SIGNS

100 device
101 laser device
102 laser radiation
103 holding device
110 paperboard
111 first cover layer
112 second cover layer
113 core section
114 penetrating region
401 step of providing
402 step of adjusting a moisture
403 step of penetrating
404 step of creasing
201 creasing line
301 penetration spots
501 graphic structure
800 conventional paperboard
801 inner liner
802 outer liner
803 conventional creasing rule
804 conventional support table
805 cavity

1. A method for locally modifying a structure of a paperboard further comprising:
providing the paperboard;
penetrating a penetrating region of the paperboard by laser radiation such that moisture in the penetrating region evaporates for modifying the structure of the penetrating region.

2. A method according to claim 1, further comprising:
after evaporation of the moisture creasing the paperboard along the penetrating region, wherein the penetrating region describes a creasing line along which the paperboard is intended to be bent.

3. A method according to claim 1, wherein the provided paperboard comprises a first cover layer covering a core section of the paperboard;
wherein during the step of penetrating the penetrating region, penetrating the penetrating region such that the evaporated moisture deforms at least the first cover layer;
wherein the penetrating region then describes an embossing structure a Braille letter, a number or a symbol.

4. A method according to claim 3, further comprising:
adjusting a swelling level within the core section at the penetrating region before the step of penetrating the penetrating region; and
wherein the step of adjusting the swelling level comprises introducing at least one swelling additive adapted for swelling under influence of the laser radiation such that the embossing structure of the first layer is generated.

5. A method according to claim 1, further comprising:
adjusting a moisture level within the core section at the penetrating region before the step of penetrating the penetrating region;
wherein the step of adjusting the moisture level comprises introducing at least one moisture levelling additive for causing gas generation by the laser radiation within a core section of the paperboard at the penetrating region such that the penetrating region is weakened.

6. A method according to claim 1, wherein the laser radiation comprises a power density of 10⁴ W/cm² to 10⁶ W/cm², preferably 10⁵ W/cm².

7. A method according to claim 1, wherein the laser radiation comprises deposited power of 10 W/cm² to 10³ W/cm², preferably 10² W/cm² W/cm².

8. A method according to claim 1, wherein the laser radiation has a wavelength of 1000 nm to 11000 nm, in particular 4000 nm to 8000 nm.

9. A method according to claim 1, wherein the laser radiation is a pulsed laser radiation generated by a pulsed laser device.

10. A method according to claim 1, wherein the laser radiation is a continuous laser radiation generated by a continuous laser device.

11. A method according to claim 1, wherein the laser radiation is generated by a diode laser.

12. A method according to claim 1, wherein the laser radiation is generated by Nd:YAG 1064 nm laser or a Ytterbium doped fibre laser 1074 nm.

13. A method according to claim 1, wherein the laser radiation is generated by a carbon dioxide laser.

14. A device for locally modifying a structure of a paperboard, the device comprising:
a holding device for holding the paperboard;
a laser device configured for penetrating a penetrating region of the paperboard by laser radiation such that the moisture in the penetrating region evaporates for locally modifying the structure of the penetrating region.

15. A device according to claim 14, further comprising a bending device for bending the paperboard along the penetrating region.

16. A method according to claim 1, wherein the provided paperboard comprises a first cover layer covering a core section of the paperboard; and
wherein during the step of penetrating the penetrating region, penetrating the penetrating region such that the evaporated moisture deforms at least the first cover layer.
